(19) United States
(12) Patent Application Publication
(10) Pub. No.: US 2024/0332881 A1
(43) Pub. Date: Oct. 3, 2024

(54) STRUCTURE, RELEASE JIG AND UNLOCKING METHOD OF LOCK OF STRUCTURE USING RELEASE JIG

(71) Applicant: JAPAN AVIATION ELECTRONICS INDUSTRY, LIMITED, Tokyo (JP)

(72) Inventor: Kenta KUMAGAI, Tokyo (JP)

(73) Assignee: JAPAN AVIATION ELECTRONICS INDUSTRY, LIMITED, Tokyo (JP)

(21) Appl. No.: 18/438,688

(22) Filed: Feb. 12, 2024

(30) Foreign Application Priority Data
Mar. 31, 2023 (JP) 2023-057049

(51) Int. Cl. H01R 43/26; H01R 13/627

(52) U.S. Cl. CPC H01R 43/26; H01R 13/6273

(57) ABSTRACT

A structure comprises a first member and a second member. The first member has a lock arm which extends along a front-rear direction and is resiliently deformable. The lock arm has a lock portion and a released portion provided on a rear end part of the lock arm. The second member has a locked portion, a facing portion and a guide channel extending along an up-down direction. The lock portion locks the locked portion under a mated state of the first member and the second member, and the mated state is locked. The facing portion is located forward of the guide channel and faces the released portion in a lateral direction when the first member and the second member are under the mated state. When the structure under the mated state is seen along the up-down direction, a gap located between the facing portion and the released portion is visible.

### CROSS REFERENCE TO RELATED APPLICATIONS

This application is based on and claims priority under 35 U.S.C. § 119 to Japanese Patent Application No. JP 2023-057049 filed Mar. 31, 2023, the content of which is incorporated herein in its entirety by reference.

### BACKGROUND OF THE INVENTION

This invention relates to a structure comprising a first member and a second member mateable with each other and a release jig configured to unlock a lock of a mated state of this structure.

For example, this type of structure and release jig is disclosed in JP2018-098114A (Patent Document 1), the content of which is incorporated herein by reference.

Referring to FIGS. 17 and 18, Patent Document 1 discloses a female connector (structure) 90 comprising a female housing (first member) 91 and a front holder (second member) 93 mateable with each other. The first member 91 is formed with an engagement hole (locked portion) 92. The second member 93 has a resiliently deformable lock arm 94. The lock arm 94 has an engagement projection (lock portion) 95. When the first member 91 and the second member 93 are mated with each other, the lock portion 95 is received in the locked portion 92, and thereby the mated state of the structure 90 is locked.

The aforementioned lock of the mated state can be unlocked with a release jig 97 such as a flathead screwdriver as described below. First, an end 98 of the release jig 97 is inserted under the lock arm 94. Then, the release jig 97 is used as a leverage having a fulcrum so that the lock arm is forcibly moved upward. As a result, the lock portion comes off the locked portion, and the lock of the mated state is unlocked.

According to the unlocking method disclosed in Patent Document 1, the release jig must be handled carefully and appropriately. For example, when an excessively large force is applied to the release jig, the release jig might be damaged.

### SUMMARY OF THE INVENTION

It is therefore an object of the present invention to provide an unlocking method which enables a lock of a mated state to be easily unlocked without damaging a lock arm. It is also an object of the present invention to provide a release jig and a structure suitable for this unlocking method.

An aspect of the present invention provides an unlocking method for unlocking a lock of a mated state of a structure comprising a first member and a second member by using a release jig. The second member is mateable with the first member, which is located forward of the second member in a front-rear direction, along the front-rear direction. The first member has a lock arm. The lock arm extends along the front-rear direction and is resiliently deformable. The lock arm has a lock portion and a released portion. The released portion is provided on a rear end part of the lock arm. The second member has a locked portion, a facing portion and a guide channel. The lock portion locks the locked portion under the mated state where the first member and the second member mated with each other, and thereby the mated state is locked. The guide channel extends along an up-down direction perpendicular to the front-rear direction. The facing portion is located forward of the guide channel and faces the released portion in a lateral direction perpendicular to both the front-rear direction and the up-down direction when the first member and the second member are under the mated state. When the structure under the mated state is seen along the up-down direction, a gap located between the facing portion and the released portion is visible. The release jig has a guided portion and a release portion. The guided portion extends along the up-down direction. The release portion is located forward of the guided portion. The unlocking method comprises: moving the release jig along the up-down direction in a state where the guide portion regulates a movement of the guided portion in the front-rear direction, so that the release portion is inserted into the gap; and resiliently deforming the lock arm by the release portion inserted in the gap to cause the released portion of the lock arm to be moved outward of the structure in the lateral direction, so that the locked portion locked by the lock portion is unlocked.

Another aspect of the present invention provides a release jig configured to unlock a lock of a mated state of a structure which comprises a first member and a second member mateable with each other. The first member has a lock arm. The lock arm extends along a front-rear direction and is resiliently deformable. The lock arm has a lock portion. The second member has a locked portion. The lock portion locks the locked portion under the mated state where the first member and the second member mated with each other, and thereby the mated state is locked. The release jig has a guided portion and a release portion. The guided portion extends along an up-down direction perpendicular to the front-rear direction. The release portion is located forward of the guided portion. The release portion is insertable inward of the lock arm in a lateral direction perpendicular to both the front-rear direction and the up-down direction by moving the release jig along the up-down direction while a movement of the guided portion in the front-rear direction is regulated. The release portion resiliently deforms the lock arm when inserted inward of the lock arm in the lateral direction and thereby unlocks the locked portion locked by the lock portion.

Still another aspect of the present invention provides a structure comprising a first member and a second member mateable with each other. The first member has a lock arm. The lock arm extends along a front-rear direction and is resiliently deformable. The lock arm has a lock portion and a released portion. The released portion is provided on a rear end part of the lock arm. The second member has a locked portion, a facing portion and a guide channel. The lock portion locks the locked portion under a mated state where the first member and the second member mated with each other, and thereby the mated state is locked. The guide channel extends along an up-down direction perpendicular to the front-rear direction. The facing portion is located forward of the guide channel and faces the released portion in a lateral direction perpendicular to both the front-rear direction and the up-down direction when the first member and the second member are under the mated state. When the structure under the mated state is seen along the up-down direction, a gap located between the facing portion and the released portion is visible.

According to an aspect of the present invention, the lock arm can be resiliently deformed not based on the principle of leverage but merely by moving the release jig downward along the up-down direction, and thereby the lock of the mated state can be unlocked. When the release jig is moved downward, there is no need to adjust a force applied to the release jig. Thus, an aspect of the present invention provide the unlocking method which enables the lock of the mated state to be easily unlocked without damaging the lock arm. An aspect of the present invention also provides the release jig and the structure suitable for this unlocking method.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a perspective view showing a structure according to an embodiment of the present invention, wherein a first member and a second member of the structure are under a separated state where they are separated from each other.

FIG. 2 is a perspective view showing the structure of FIG. 1 together with a release jig, wherein the first member and the second member are under a mated state where they are mated with each other, and the release jig is apart from the structure.

FIG. 3 is a perspective view showing the first member of the structure of FIG. 1, wherein a part of the first member enclosed by dashed line is enlarged and illustrated.

FIG. 4 is a top view showing the structure of FIG. 2, wherein cables are not illustrated, and a part of the structure enclosed by dashed line is enlarged and illustrated.

FIG. 5 is a front view showing the structure of FIG. 4.

FIG. 6 is a cross-sectional view showing the structure of FIG. 5, taken along line VI-VI, wherein a rear part of the second member is not illustrated, and a part of the structure enclosed by dashed line is enlarged and illustrated.

FIG. 7 is a perspective view showing the release jig of FIG. 2, wherein a part of the release jig enclosed by dashed line is enlarged and illustrated.

FIG. 8 is another perspective view showing the release jig of FIG. 7, wherein a part of the release jig enclosed by dashed line is enlarged and illustrated.

FIG. 9 is a front view showing the release jig of FIG. 7, wherein a part of the release jig enclosed by dashed line is enlarged and illustrated.

FIG. 10 is a rear view showing the structure and the release jig of FIG. 2, wherein a part of the structure enclosed by dashed line is enlarged and illustrated, and in the enlarged view, an outline of a release portion of the release jig which is moved downward is illustrated with dashed line.

FIG. 11 is a cross-sectional view showing the structure and the release jig of FIG. 10, taken along line XI-XI, wherein the cables are not illustrated, and a part of the structure and the release jig enclosed by dashed line is enlarged and illustrated.

FIG. 12 is a front view showing the structure and the release jig of FIG. 2, wherein the release jig is attached to the structure.

FIG. 13 is a cross-sectional view showing the structure and the release jig of FIG. 12, taken along line XIII-XIII, wherein a rear part of the second member is not illustrated, and a part of the structure and the release jig enclosed by dashed line is enlarged and illustrated.

FIG. 14 is a perspective view showing the structure and the release jig of FIG. 12, wherein the first member is detached from the second member.

FIG. 15 is a front view showing the second member and the release jig of FIG. 14.

FIG. 16 is a cross-sectional view showing the second member and the release jig of FIG. 15, taken along line XVI-XVI, wherein a rear part of the second member is not illustrated.

FIG. 17 is a perspective view showing a structure and a release jig of Patent Document 1, wherein a part of the structure and the release jig enclosed by chain dotted line is enlarged and illustrated.

FIG. 18 is a cross-sectional view showing a part of the structure and the release jig of FIG. 17.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

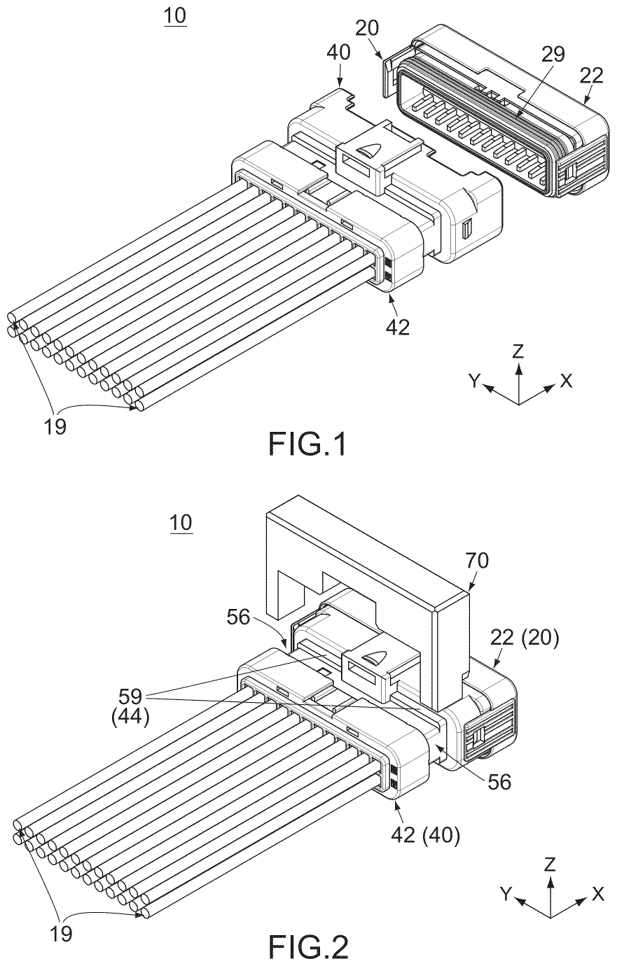

As shown in FIG. 1, a structure 10 according to an embodiment of the present invention comprises a first member 20 and a second member 40. In detail, referring to FIGS. 1 and 2, the structure 10 comprises the first member 20 and the second member 40 mateable with each other. The second member 40 is mateable with the first member 20, which is located forward of the second member 40 in a front-rear direction, along the front-rear direction. Thus, a mating direction of the present embodiment is the front-rear direction and the X-direction. In the present embodiment, “forward” means the positive X-direction, and “rearward” means the negative X-direction. However, the words such as the front-rear direction, forward and rearward do not indicate an absolute relation relative to the ground but merely indicate a relative relation in the figures. For example, the front-rear direction of the present invention is a direction along which the first member 20 and the second member 40 are arranged when they are mated with each other.

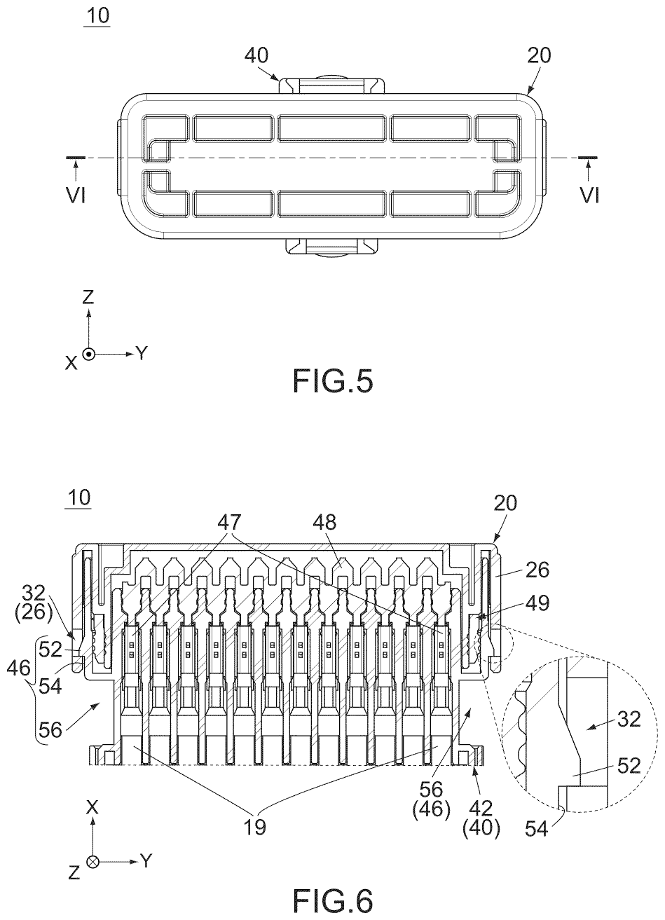

Referring to FIG. 1, the illustrated structure 10 is under a separated state where the first member 20 and the second member 40 are separated from each other. Referring to FIGS. 1 and 2, the structure 10 is used under a mated state shown in FIG. 2 where the first member 20 and the second member 40 are mated with each other. More specifically, the structure 10 of the present embodiment is a branch connector with a waterproof configuration and connects two or more cables 19 with each other in accordance with a predetermined relation for connection when the structure 10 is used. The second member 40 of the present embodiment is a body of this connector. The first member 20 of the present embodiment is a front cover of this connector. Referring to FIGS. 4 and 5, the first member 20 covers the second member from front under the mated state and protects the second member 40.

The structure 10 of the present embodiment has the aforementioned configuration. However, the configuration of the structure 10 of the present invention is not specifically limited. For example, the structure 10 does not need to have any waterproof configurations. Moreover, the structure 10 may be a connector device which electrically connects an electronic device (not shown) and a mating electronic device (not shown) with each other. In this instance, the first member 20 may be a connector connected to the electronic device, and the second member 40 may be a mating connector connected to the mating electronic device.

Referring to FIGS. 1 and 2, the mated state of the structure 10 shown in FIG. 2 is locked as described later. More specifically, the mated state cannot be released merely by exerting, on the first member 20, a force which urges the first member 20 to be separated from the second member 40 in the front-rear direction. However, as described later, the mated state can be easily released by using a release jig 70. The release jig 70 is arranged above the structure 10 in an up-down direction perpendicular to the front-rear direction when the mated state of the structure 10 is released. The up-down direction of the present embodiment is the Z-direction. In the present embodiment, “upward” means the positive Z-direction, and “downward” means the negative Z-direction. The up-down direction does not need to be equal to the gravity direction. The up-down direction of the present invention is a direction along which the structure 10 and the release jig 70 are arranged when the mated state of the structure 10 is released.

Hereafter, explanation will be made about the first member 20 of the present embodiment.

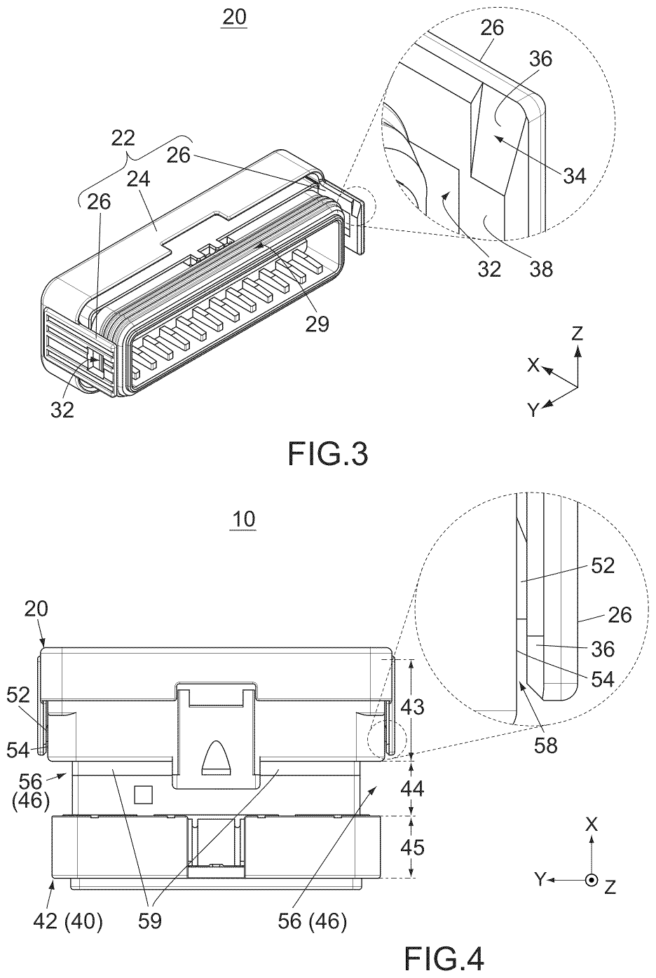

Referring to FIG. 3, the first member 20 of the present embodiment has a box-like shape which opens rearward. The first member 20 of the present embodiment comprises a first housing 22 made of insulator and comprises a waterproof member 29 made of elastomer. However, the present invention is not limited thereto. For example, the first member 20 may comprise only the first housing 22.

The first member 20 of the present embodiment has a base portion 24 and two lock arms 26. The base portion 24 is a front part of the first member 20 and extends longer in a lateral direction perpendicular to both the front-rear direction and the up-down direction than in the front-rear direction. The two lock arms 26 are located at opposite sides of the base portion 24 in the lateral direction, respectively. The thus-located two lock arms 26 are apart from each other in the lateral direction. The lateral direction of the present embodiment is the Y-direction. The two lock arms are arranged so that they are mirror images of each other with respect to a predetermined plane (XZ-plane) perpendicular to the lateral direction.

Each of the lock arms 26 extends along the front-rear direction. In detail, each of the lock arms 26 extends rearward from a rear edge of the base portion 24. In other words, each of the lock arms 26 of the present embodiment is a predetermined part of a side part of the first member 20 in the lateral direction, the predetermined part projecting rearward from the rear edge of the base portion 24.

Each of the lock arms 26 has a thin flat-plate shape perpendicular to the lateral direction. As can be seen from this configuration, each of the lock arms 26 is a cantilever and is resiliently deformable. A front end of each of the lock arms 26 is a fixed end fixed to the rear edge of the base portion 24 and is hardly moved even when the lock arm 26 is resiliently deformed. In contrast, a rear end of each of the lock arms 26 is a free end and is movable in the lateral direction in accordance with a resilient deformation of the lock arm 26.

The first member 20 of the present embodiment has two of the lock arms 26 each having the aforementioned configuration. In other words, the lock arm 26 of the first member 20 includes two lock arms 26. However, the present invention is not limited thereto. For example, the number of the lock arms 26 may be one.

Each of the lock arms 26 of the present embodiment has an inner surface 38. Each of the inner surfaces 38 is an inside surface of the lock arm 26 in the lateral direction. The two inner surfaces 38 face each other in the lateral direction with a rear part of the first member 20 located therebetween. Each of the inner surfaces 38 is a flat surface perpendicular to the lateral direction when the lock arm 26 is not resiliently deformed.

Each of the lock arms 26 has a lock portion 32 and a released portion 36. Each of the lock arms 26 is formed with a rectangular lock hole 32 and a recess 34.

Each of the lock holes 32 of the present embodiment is a hole which passes through the lock arm 26 in the lateral direction. Each of the lock holes 32 is located at a middle part of the lock arm 26 in the front-rear direction. Each of the lock holes 32 works as the lock portion 32.

Each of the recesses 34 of the present embodiment is a recess formed on the inner surface 38. Each of the recesses 34 is located at a rear end part of the lock arm 26. Each of the recesses 34 opens rearward and is recessed toward an outside surface of the first member 20 in the lateral direction.

Each of the released portions 36 of the present embodiment is a sloping surface of the recess 34 which intersects with the up-down direction. In detail, each of the released portions 36 of the present embodiment is a sloping surface which is oblique to the up-down direction and is in parallel to the front-rear direction. Each of the released portions 36 has a lower end which is connected to the inner surface 38. Each of the released portions 36 extends upward and outward in the lateral direction from the lower end of the released portion 36. Each of the released portions 36 is provided on the rear end part of the lock arm 26. Each of the thus-arranged released portions 36 is easily movable in the lateral direction. When the first member 20 is seen from behind along the front-rear direction, front inner wall surfaces on the recesses 34 and rear edges of the released portions 36 are visible.

The first member 20 of the present embodiment has the aforementioned configuration. However, the configuration of the first member 20 is not specifically limited, provided that the first member 20 has at least one of the lock arms 26 which is provided with the lock portion 32 and the released portion 36.

Hereafter, explanation will be made about the second member 40 (see FIG. 4) of the present embodiment.

Referring to FIGS. 4 and 6, the second member 40 of the present embodiment comprises a second housing 42 made of insulator, a waterproof member 49 made of elastomer, two or more terminals 47 attached to the cables 19 and a coupling member 48 which couples the terminals 47 together. One or more parts of the coupling member 48 are removed as necessary so that the cables 19 connected to the terminals 47 are divided into two or more groups. When the cables 19 are divided as describe above, only the cables 19 of the same group can be connected to each other. However, the present invention is not limited thereto. For example, the second member 40 may comprise only the second housing 42.

Referring to FIG. 4, the second member 40 of the present embodiment has a mirror-symmetric shape with respect to the XZ-plane. The second member 40 has a front portion 43, a narrow portion 44 and a rear portion 45. The front portion 43 is a front part of the second member 40. The rear portion 45 is a rear part of the second member 40. The narrow portion 44 is a part of the second member 40 which is located between the front portion 43 and the rear portion 45 in the front-rear direction. Thus, the narrow portion 44 is located at a middle part of the second member 40 in the front-rear direction. The narrow portion 44 has a size in the lateral direction which is smaller than another size of each of the front portion 43 and the rear portion 45 in the lateral direction. In other words, the narrow portion 44 has opposite sides in the lateral direction which are recessed inward in the lateral direction.

According to the aforementioned configuration, the second member 40 is formed with two channels, namely guide channels 56, which are recessed in the lateral direction. Thus, the second member 40 of the present embodiment has the two guide channels 56. The two guide channels 56 are located at opposite sides of the narrow portion 44 in the lateral direction, respectively. Each of the guide channels is a space defined by a rear end surface of the front portion 43, a front end surface of the rear portion 45 and a side surface of the narrow portion 44 in the lateral direction. Each of the guide channels 56 extends along the up-down direction. Each of the rear end surfaces of the front portion 43 and the front end surfaces of the rear portion 45 is a flat surface perpendicular to the front-rear direction. Each of the opposite surfaces of the narrow portion 44 in the lateral direction is a flat surface perpendicular to the lateral direction.

Each of the guide channels 56 of the present embodiment has the aforementioned configuration. However, the present invention is not limited thereto. For example, each surface which defines the guide channel 56 may be a curved surface or may be an uneven surface.

Referring to FIG. 4 together with FIG. 6, the second member 40 of the present embodiment has two locked portions 52 and two facing portions 54.

Referring to FIG. 4, the two locked portions 52 of the present embodiment are located at opposite sides of the front portion 43 in the lateral direction, respectively. Each of the locked portions 52 projects outward in the lateral direction from a side surface of the front portion 43 in the lateral direction. Each of the locked portions 52 has a rear end which extends along the lateral direction.

The two facing portions 54 of the present embodiment are located on the opposite sides of the front portion 43 in the lateral direction, respectively. Each of the facing portions 54 is a part of the side surface of the front portion 43 in the lateral direction. Each of the facing portions 54 has a lower part which is a flat surface perpendicular to the lateral direction. Each of the facing portions 54 has an upper part which is a curved surface curved inward in the lateral direction. The two facing portions 54 correspond to the two locked portions 52, respectively, and correspond to the two guide channels 56, respectively. More specifically, each of the facing portions is located rearward of the corresponding locked portion 52 and is located forward of the corresponding guide channel 56. In other words, each of the facing portions 54 is located between the corresponding locked portion 52 and the corresponding guide channel 56 in the front-rear direction.

Explaining the arrangement of the locked portions 52, the facing portions 54 and the guide channels 56 of the present embodiment from another viewpoint, the second member 40 has two side portions 46. The two side portions 46 are located at opposite sides of the second member 40 in the lateral direction, respectively. Each of the side portions 46 of the present embodiment includes a side part of the front portion 43 in the lateral direction, a side part of the narrow portion 44 in the lateral direction and a side part of the rear portion 45 in the lateral direction. Each of the thus-defined side portions 46 has the locked portion 52, the facing portion 54 and the guide channel 56.

Referring to FIG. 6, the second member 40 of the present embodiment has two sets each consisting of the locked portion 52, the facing portion 54 and the guide channel 56 which have the aforementioned configurations. These two sets correspond to the two lock arms 26 of the first member 20, respectively. The second member 40 has the two side portions 46 which are formed with the two sets, respectively. However, the present invention is not limited thereto. For example, in an instance in which only one of the lock arms 26 is provided, only one of the two side portions 46 may be formed with the locked portion 52, the facing portion 54 and the guide channel 56. In other words, each of the number of the locked portions 52, the number of the facing portions 54 and the number of the guide channels 56 may be one.

Referring to FIG. 4 together with FIG. 2, the second member 40 of the present embodiment has two stop portions 59 in addition to the aforementioned portions. Each of the stop portions 59 is an upper surface of a projecting part formed on the narrow portion 44. Each of the stop portions 59 faces upward. The two stop portions are arranged in the lateral direction and are located between the two guide channels 56 in the lateral direction. Each of the stop portions 59 extends along a horizontal plane (XY-plane) perpendicular to the up-down direction. The stop portions of the present embodiment are provided as described above. However, the present invention is not limited thereto. For example, the stop portions 59 may be provided as necessary. Each of the stop portions 59 may be a curved surface or an uneven surface.

The second member 40 of the present embodiment has the aforementioned configuration. However, the configuration of the second member 40 is not specifically limited, provided that the second member 40 has at least one of the sets which consists of the locked portion 52, the facing portion 54 and the guide channel 56.

Hereafter, explanation will be made about the mated state of the structure 10 of the present embodiment.

Referring to FIG. 6, under the mated state, a front end of the second member 40 is received in the first member 20, and each of the locked portions 52 is received in the lock portion 32 of the corresponding lock arm 26. When a forward force is applied to the first member 20, the rear end of each of the locked portions 52 which is perpendicular to the front-rear direction is brought into abutment with an inner wall surface of the lock portion 32 which is perpendicular to the front-rear direction. Accordingly, the mated state cannot be released merely by exerting, on the first member 20, a force which urges the first member 20 to be separated from the second member 40 in the front-rear direction.

As described above, the lock portions 32 lock the locked portions 52 under the mated state, and thereby the mated state is locked. According to the present embodiment, the two lock portions 32, which are located at opposite sides of the first member 20 in the lateral direction, lock the two locked portions 52 which are located at opposite sides of the second member 40 in the lateral direction. According to this configuration, the mated state can be more securely locked.

According to the present embodiment, each of the lock portions 32 is a hole which passes through the lock arm 26, and each of the locked portions 52 is a projection. The locked portions 52 are engaged with the lock portions 32 under the mated state. However, the configuration of each of the lock portions 32 and the locked portions 52 is not specifically limited, provided that the lock portions 32 can lock the locked portions 52. For example, each of the lock portions 32 may be a hole whose outer part in the lateral direction is covered. Each of the lock portions 32 may be a projection, and each of the locked portions 52 may be a hole.

Each of the locked portions 52 of the present embodiment is fixed so that each of the locked portions 52 is unmovable relative to the second member 40. In contrast, each of the lock portions 32 is movable relative to the locked portion 52 by resiliently deforming the lock arm 26. However, as shown in FIG. 4, the lock arms 26 are wholly located forward of the guide channels 56 under the mated state of the present embodiment. According to this configuration, under the mated state, any part located inward of the lock arms 26 in the lateral direction is not formed with a large space which allows a finger to be inserted therein. Accordingly, the mated state can be prevented from unintentional release which might be caused because of an unintentional resilient deformation of the lock arms 26. The locked portions 52 locked by the lock portions 32 can be unlocked by intentionally moving each of the lock portions 32 outward in the lateral direction, and thereby the lock of the mated state can be unlocked.

In detail, the facing portions 54 of the second member 40 face the released portions 36 of the first member 20 in the lateral direction, respectively, when the first member 20 and the second member 40 are under the mated state. When the structure 10 under the mated state is seen along the up-down direction, gaps 58 are visible. Each of the gaps 58 is located between one of the facing portions 54 and the corresponding released portion 36. This arrangement is suitable for an operation in which a jig is moved along the up-down direction and is inserted into the gaps 58. According to this arrangement, each of the lock portions 32 can be moved outward in the lateral direction by inserting the jig into the gaps 58. In other words, the structure of the present embodiment has a configuration which is suitable to release the mated state by using a jig.

Hereafter, explanation will be made about the release jig 70 (see FIG. 2) which is suitable as the aforementioned jig.

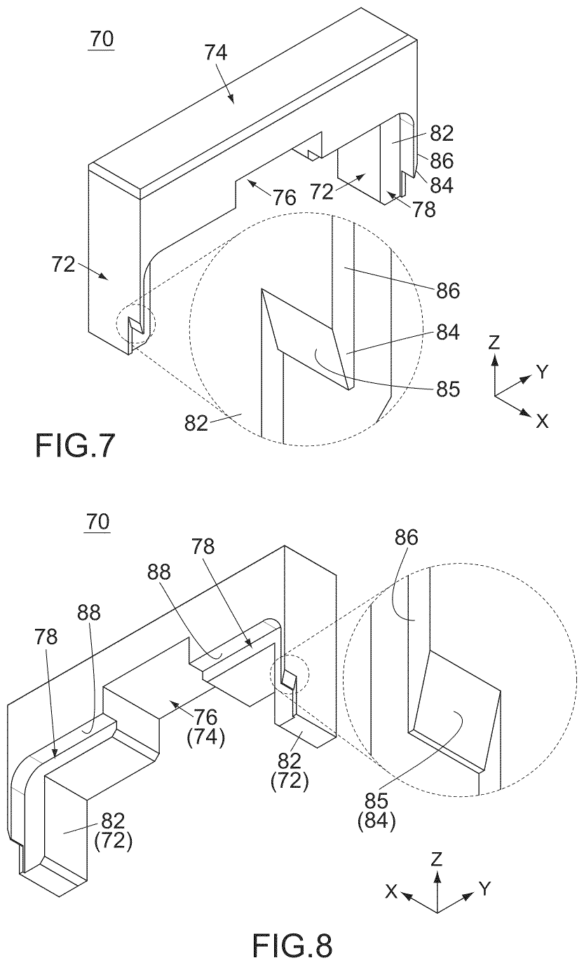

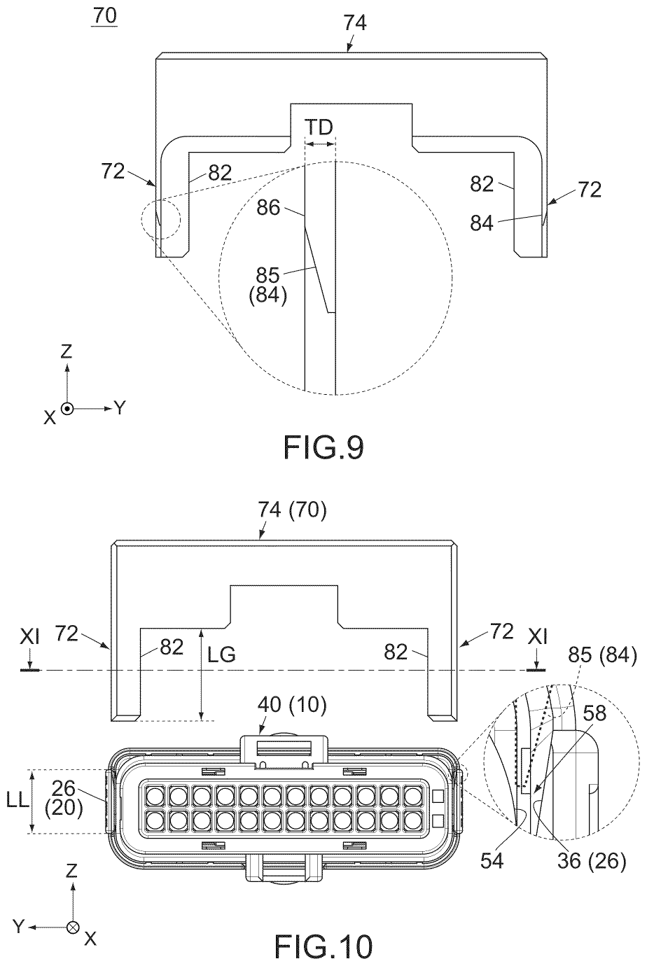

Referring to FIG. 9, the release jig 70 of the present embodiment is molded of insulator such as resin and has a mirror-symmetric shape with respect to the XZ-plane. Referring to FIGS. 7 and 8, the release jig 70 has two arms 72 and a coupling portion 74. Each of the arms 72 and the coupling portion 74 has a rectangular rod-like shape. The coupling portion 74 couples the two arms 72 together in the lateral direction. Each of the arms 72 extends downward from the coupling portion 74. Upper ends of the two arms 72 are connected to opposite ends of the coupling portion 74 in the lateral direction, respectively.

The release jig 70 is formed with a middle groove 76 and an inner recess 78. The middle groove 76 is located at a middle part of the coupling portion 74 in the lateral direction. The middle groove 76 is a groove opening downward and passes through the coupling portion 74 along the front-rear direction. The inner recess 78 is a recess which is recessed rearward from a front surface of the release jig 70. The thus-formed inner recess 78 is located in a front end part of the release jig 70 and opens forward. The inner recess 78 is formed so that an inner circumference of the release jig 70 in a vertical plane (YZ-plane) is partially cut out. The inner recess 78 extends between lower ends of the two arms 72 in the YZ-plane with the middle groove 76 located therebetween.

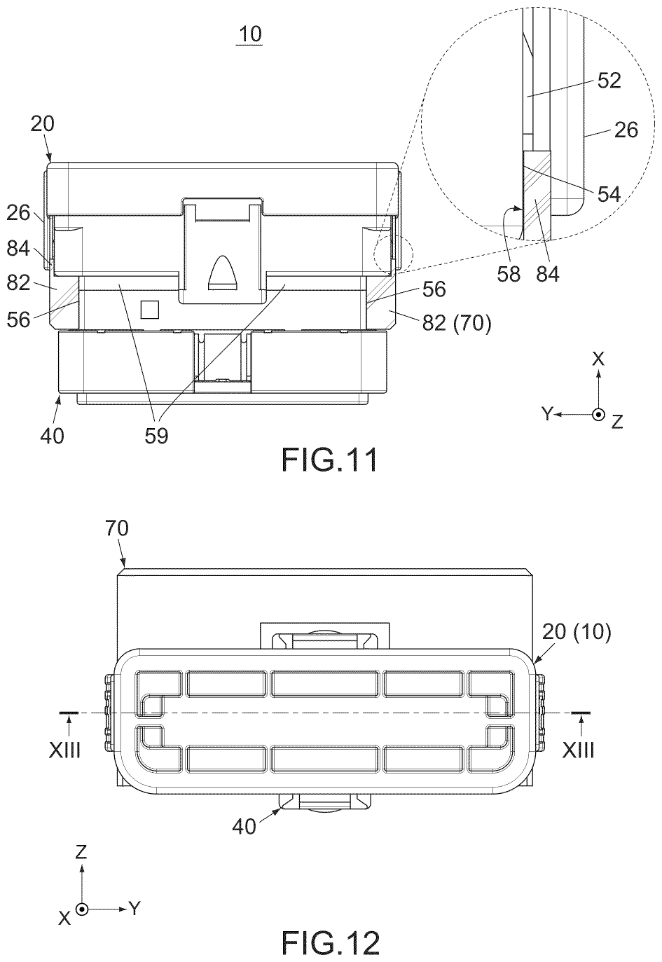

Each of the arms 72 of the present embodiment has a guided portion 82 and a release portion 84. Thus, the release jig 70 of the present embodiment has two of the guided portions 82 and two of the release portions 84. In other words, the release jig 70 has two sets each consisting of the guided portion 82 and the release portion 84. These two sets correspond to the two lock arms 26 (see FIG. 11) of the first member 20 (see FIG. 11), respectively. However, the present invention is not limited thereto. For example, in an instance in which only one of the lock arms 26 is provided, the release jig 70 may have one of the guided portions 82 and one of the release portions 84. More specifically, the release jig 70 may have only one of the arms 72.

Each of the guided portions 82 of the present embodiment is a rear part of the arm 72. Each of the guided portions 82 extends along the up-down direction. Referring to FIG. 11 together with FIG. 4, each of the guided portions 82 has a rectangular shape in the XY-plane which corresponds to the guide channel 56 of the second member 40.

More specifically, each of the guided portions 82 has a size in the front-rear direction which is equal to another size of the corresponding guide channel 56 in the front-rear direction. Each of the guided portions 82 has a front surface and a rear surface each of which is a flat surface perpendicular to the front-rear direction. Each of the guided portions 82 has an inner surface in the lateral direction which is a flat surface perpendicular to the lateral direction. The minimum distance between the two guided portions 82 in the lateral direction is equal to the minimum distance between the two guide channels 56 in the lateral direction. As can be seen from the aforementioned configuration, the release jig 70 of the present embodiment has a configuration which enables the two guided portions 82 to be simultaneously inserted into the two guide channels 56.

The guided portions 82 of the present embodiment have the aforementioned configuration. However, the present invention is not limited thereto. For example, each surface of the guided portions 82 may be a curved surface or may be an uneven surface.

Referring to FIGS. 7 and 8, each of the release portions 84 of the present embodiment is a front part of the arm 72. Thus, each of the release portions 84 is located forward of the guided portion 82. Each of the release portions 84 is located outward of the inner recess 78 in the lateral direction. Each of the release portions 84 of the present embodiment has a release surface 85 and a deformation maintenance portion 86.

Each the release surfaces 85 is located on an outside part of the release portion 84 in the lateral direction and faces outward in the lateral direction. Each the release surfaces 85 of the present embodiment is a sloping surface which is oblique to the up-down direction and is in parallel to the front-rear direction. Each the release surfaces 85 extends upward and outward in the lateral direction from a lower end of the release portion 84. Each of the release portions 84 also has an inside surface in the lateral direction which is a flat surface perpendicular to the lateral direction. Each of the release portions 84 has a size in the lateral direction which is gradually enlarged upward. When the release jig 70 is seen from front along the front-rear direction, front surfaces of the release portions 84 are visible.

Referring to FIGS. 7 to 9, each of the deformation maintenance portions 86 is an upper part of the release portion 84. Each of the deformation maintenance portions 86 has an inside surface in the lateral direction which is a flat surface perpendicular to the lateral direction and extends upward from an upper end of the inside surface of the release portion 84 in the lateral direction. Each of the deformation maintenance portions 86 has an outside surface in the lateral direction which is a flat surface perpendicular to the lateral direction and extends upward from an upper end of the release surface 85. Thus, each of the deformation maintenance portions 86 has a constant size TD in the lateral direction.

Each of the release portions 84 of the present embodiment has the aforementioned configuration. However, the present invention is not limited thereto. For example, the deformation maintenance portions 86 may be provided as necessary.

Referring to FIG. 8, the coupling portion 74 of the present embodiment has two abutment portions 88. Thus, the release jig 70 of the present embodiment has the two abutment portions 88 in addition to the aforementioned portions. Each of the abutment portions 88 is an upper surface of the inner recess 78 formed in the coupling portion 74. Each of the abutment portions 88 faces downward. The two abutment portions 88 are arranged in the lateral direction and are located between the two guided portions 82 in the lateral direction. Each of the abutment portions 88 is a flat surface perpendicular to the up-down direction. The abutment portions 88 of the present embodiment are provided as described above. However, the present invention is not limited thereto. For example, the abutment portions 88 may be provided as necessary. Each of the abutment portions 88 may be a curved surface or may be an uneven surface.

Hereafter, explanation will be made about an unlocking method for unlocking the mated state of the structure 10 (see FIG. 2) by using the release jig 70 of the present embodiment, the structure 10 comprising the first member 20 (see FIG. 2) and the second member 40 (see FIG. 2) mateable with each other. Hereafter, this unlocking method is merely referred to as “unlocking method of the present embodiment”. The unlocking method of the present embodiment described below is merely an example and can be modified as necessary.

Referring to FIGS. 10 and 11, first, the release jig 70 is arranged above the structure 10. Meanwhile, the two arms 72 are arranged below the coupling portion 74. The release jig 70 is arranged so that each of the arms 72 straight extends along the up-down direction. In addition, the two guided portions 82 are arranged just above the two guide channels 56.

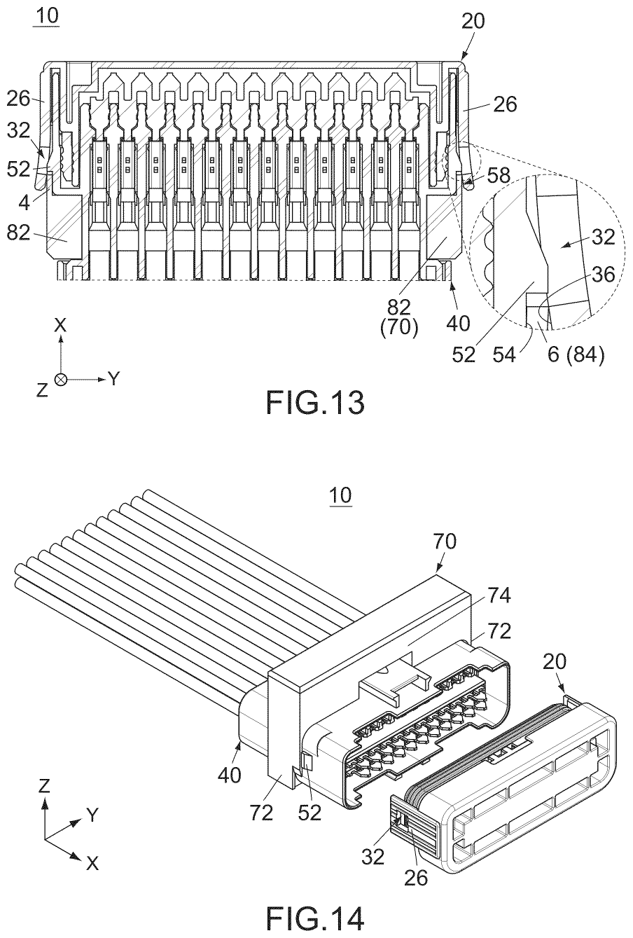

Referring to FIGS. 10 and 12, then, the release jig 70 is moved downward toward the structure 10. As shown in FIG. 9, each of the guided portions 82 extends downward beyond the lower end of the release portion 84. In other words, a lower end of each of the guided portions 82 is located below another lower end of the release portion 84. Accordingly, referring to FIGS. 11 and 13, the two guided portions are first received in the two guide channels 56, respectively, in the aforementioned movement. As a result, the release portions 84 are positioned in the XY-plane. When the release jig 70 is kept being moved downward, the thus-positioned release portions 84 are inserted into the gaps 58 without being misaligned in each of the front-rear direction and the lateral direction.

Summarizing the explanation described above, the unlocking method of the present embodiment comprises moving the release jig 70 along the up-down direction in a state where the guide channels 56 regulate a movement of the guided portions 82 in the front-rear direction, so that the release portions 84 is inserted into the gaps 58.

Referring to FIG. 10, when the release jig 70 is kept being moved downward, the release surfaces 85 of the release portions 84 inserted in the gaps 58 are brought into contact with the released portions 36 of the lock arms 26. When the release jig is further kept being moved downward, the release surfaces 85 push the released portions 36 outward in the lateral direction. As a result, the lock arms 26 are resiliently deformed, and the released portions 36 are moved outward in the lateral direction. Referring to FIG. 13, when the release jig 70 is further kept being moved downward, the lock portion 32 of each of the lock arms 26 is moved to a position at which the lock portion 32 is not engaged with the locked portion 52 because of the movement of the released portion 36. Thus, the locked portions 52 come off the lock portions 32, and thereby the lock of the mated state is unlocked.

Summarizing the explanation described above with reference to FIGS. 10 and 13, the unlocking method of the present embodiment comprises resiliently deforming the lock arms 26 by the release portions 84 inserted in the gaps 58 to cause the released portions 36 of the lock arms 26 to be moved outward of the structure 10 in the lateral direction, so that the locked portions 52 locked by the lock portions 32 is unlocked.

As can be seen from the explanation described above, according to the present embodiment, the lock arms 26 can be resiliently deformed not based on the principle of leverage but merely by linearly moving the release jig 70 downward along the up-down direction, and thereby the lock of the mated state can be unlocked. When the release jig 70 is moved downward, there is no need to adjust a force applied to the release jig 70. Thus, the present embodiment provides the unlocking method which enables the lock of the mated state to be easily unlocked without damaging the lock arms 26.

Referring to FIG. 7 together with FIG. 13, the present embodiment also provides the release jig 70 configured to unlock the lock of the mated state of the structure 10 which comprises the first member 20 and the second member 40 mateable with each other. The release portions 84 of the release jig 70 are insertable inward of the lock arms 26 in the lateral direction by moving the release jig 70 along the up-down direction while a movement of the guided portions 82 in the front-rear direction is regulated. The release portions 84 resiliently deform the lock arms 26 when being inserted inward of the lock arms 26 in the lateral direction and thereby unlock the locked portions 52 locked by the lock portions 32. Thus, the present embodiment provides the release jig 70 suitable for the unlocking method of the present embodiment.

Moreover, referring to FIG. 4 together with FIG. 11, the present embodiment provides the structure 10 suitable for the unlocking method of the present embodiment. More specifically, the structure 10 comprises the first member 20 which has the resiliently deformable lock arms 26 and the second member 40 which has the locked portions 52 configured to be locked by the lock arms 26. The second member 40 has the guide channels 56 which guide the guided portions 82 of the release jig 70. The structure 10 under the mated state is formed with the gaps 58 into which the release portions 84 of the release jig 70 are insertable.

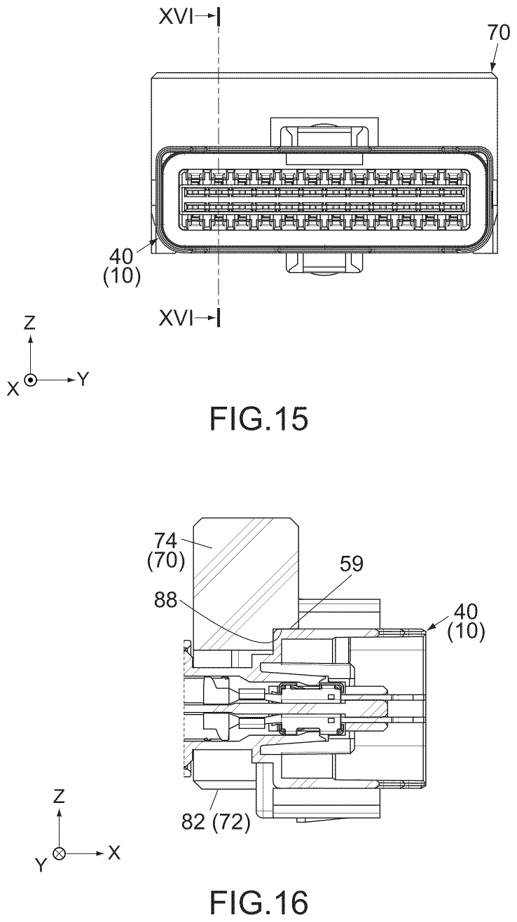

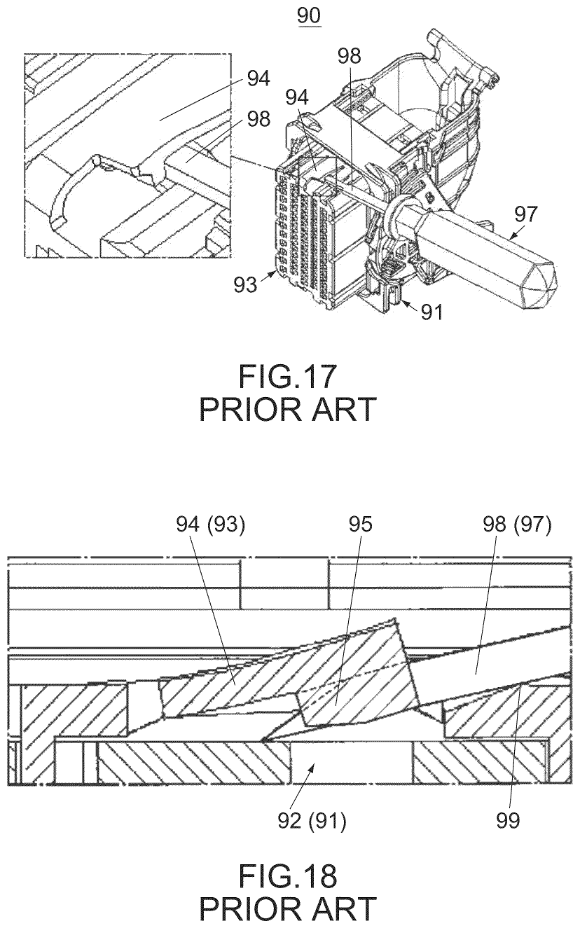

Referring to FIGS. 15 and 16, according to the unlocking method of the present embodiment, when the release jig 70 is kept being moved downward, the abutment portions 88 of the release jig 70 are brought into abutment with the stop portions 59 of the second member 40, and thereby the release jig 70 is stopped. As described above, the abutment portions 88 are brought into abutment with the stop portions 59 when the release jig 70 is moved along the up-down direction in order to unlock the locked portions 52 (see FIG. 13) locked by the lock portions 32 (see FIG. 13), and thereby the abutment portions 88 define a lower limit position of the release jig 70 in a process in which the locked portions 52 locked by the lock portions 32 are unlocked. When the release jig 70 is located at the lower limit position shown in FIGS. and 16, the lock of the mated state is unlocked. According to the present embodiment, the lock of the mated state can be unlocked merely by continuously moving the release jig 70 downward without considering the lower limit position of the release jig 70.

Referring to FIG. 13, when the release jig 70 is located at the lower limit position, the deformation maintenance portions 86 of the release portions 84 keep the state where the locked portions 52 locked by the lock portions 32 are unlocked. The lock arms 26 are not resiliently deformed excessively because each of the deformation maintenance portions 86 has a constant size in the lateral direction. According to the present embodiment, the lock of the mated state can be unlocked without damaging the lock arms 26 merely by continuously moving the release jig 70 downward. However, the present invention is not limited thereto. For example, when the release jig 70 is located at the lower limit position, the upper ends of the release surfaces 85 (see FIG. 7) may push the released portions 36 of the lock arms 26 outward in the lateral direction. In this instance, the deformation maintenance portions 86 do not need to be provided.

Referring to FIG. 13, the release portions 84 push the released portions 36 outward in the lateral direction while being pressed against the facing portions 54 inward in the lateral direction. According to this configuration, the released portions can be reliably moved outward in the lateral direction. However, the present invention is not limited thereto. For example, the release portions 84 may be apart from the facing portions 54 in the lateral direction when the release portions 84 push the released portions 36.

Referring to FIGS. 13 and 14, when the first member 20 is pulled forward after the unlocking of the lock of the mated state, the first member 20 comes off the second member 40, and the structure 10 takes the separated state shown in FIG. 14. According to the present embodiment, the first member 20 can be easily removed from the second member 40 merely by using two hands one of which pulls the first member 20 and another one of which operates the release jig 70. The release jig 70 of the present embodiment has the two arms 72 integrated with each other by the coupling portion 74 and is suitable for the aforementioned easy removing method. However, the present invention is not limited thereto. For example, in an instance in which the release jig 70 has only one of the arms 72, the lock of the mated state may be unlocked by operating two of the release jigs 70 separated from each other.

The present embodiment can be further variously modified in addition to the already described various modifications.

For example, referring to FIG. 4, according to the present embodiment, a space including the gap 58 is formed between the second member 40 and each of the whole lock arms 26 in the lateral direction. However, the present invention is not limited thereto. For example, each of the lock arms 26 may be in contact with the second member 40 except for the gap 58 formed only just above the released portions 36 of the lock arm 26. Each of the gaps 58 may be formed only between a rear end part of the released portion 36 and a rear end part of the facing portion 54.

For example, referring to FIG. 10, each of the released portions 36 of the present embodiment is a sloping surface which extends upward and outward in the lateral direction. Similarly, each of the release surfaces 85 of the release jig 70 is a sloping surface which extends upward and outward in the lateral direction. According to this configuration, the gaps 58 can be reliably formed, and the release portions 84 are easily inserted into the gaps 58. However, the present invention is not limited thereto. The shape of each of the release portions 84 and the released portions 36 is not specifically limited, provided that the released portions 36 and the facing portions form the gaps 58 under the mated state, and the released portions 36 are arranged so that they are pressable by the release portions 84.

For example, each of the release surfaces 85 may be a curved surface which intersects with the up-down direction. Thus, each of the release portions 84 may have a surface which intersects with the up-down direction. Similarly, each of the released portions 36 may be a curved surface which intersects with the up-down direction. Thus, each of the released portions 36 may be a surface of the recess 34 which intersects with the up-down direction. Moreover, only one of the release surface 85 and the released portion 36 may be a surface which intersects with the up-down direction. For example, in an instance in which the upper part of each of the facing portions 54 is formed with the illustrated curved surface and each of the gaps has a sufficiently large size in the lateral direction, each of the released portions may be a flat surface perpendicular to the lateral direction, and each of the release portions 84 may have a flat-plate shape which has a constant size in the lateral direction.

For example, referring to FIG. 3, each of the released portions 36 of the present embodiment is formed only on the rear end part of the lock arm 26. However, the present invention is not limited thereto. For example, each of the released portions 36 may be formed over the whole of the inner surface 38 in the front-rear direction. In this instance, each of the lock arms 26 is not formed with the illustrated recess 34. Thus, the recesses 34 may be provided as necessary.

Referring to FIG. 7, each of the guided portions 82 of the present embodiment is sufficiently large. More specifically, each of the guided portions 82 is larger than the release portion 84 in the lateral direction. Referring to FIG. 11, if the size of each of the guided portions 82 in the lateral direction is small, the release jig 70 might have an unstable posture during a downward movement of the release jig 70. For example, the release jig 70 might be rotated relative to the structure 10. The guided portions 82 can be reliably guided by the guide channels 56 when each of the guided portions 82 has a sufficiently large size in the lateral direction. However, the present invention is not limited thereto, but the size of each of the guided portions 82 in the lateral direction may be flexibly designed as necessary.

Referring to FIG. 10, according to the present embodiment, each of the guided portions 82 has a size LG in the up-down direction which is larger than another size LL of the lock arm 26 in the up-down direction. In other words, each of the guided portions 82 is larger than the lock arm 26 in the up-down direction. According to this configuration, each of the lock arms 26 can be reliably deformed resiliently in a process in which the guided portions 82 are guided along the up-down direction. However, the present invention is not limited thereto, but the size LG of each of the guided portions 82 in the up-down direction may be flexibly designed as necessary.

As shown in FIG. 2, each of the guide channels 56 of the present embodiment opens upward and downward. According to this configuration, the guided portions 82 can be reliably guided until the abutment portions 88 are brought into abutment with the stop portions 59 regardless of the size LG (see FIG. 10) of each of the guided portions 82 in the up-down direction. However, the present invention is not limited thereto. For example, the guide channels 56 may be covered from below.

What is claimed is:

1. An unlocking method for unlocking a lock of a mated state of a structure comprising a first member and a second member by using a release jig, wherein:
the second member is mateable with the first member, which is located forward of the second member in a front-rear direction, along the front-rear direction;
the first member has a lock arm;
the lock arm extends along the front-rear direction and is resiliently deformable;
the lock arm has a lock portion and a released portion;
the released portion is provided on a rear end part of the lock arm;
the second member has a locked portion, a facing portion and a guide channel;
the lock portion locks the locked portion under the mated state where the first member and the second member mated with each other, and thereby the mated state is locked;
the guide channel extends along an up-down direction perpendicular to the front-rear direction;
the facing portion is located forward of the guide channel and faces the released portion in a lateral direction perpendicular to both the front-rear direction and the up-down direction when the first member and the second member are under the mated state;
when the structure under the mated state is seen along the up-down direction, a gap located between the facing portion and the released portion is visible;
the release jig has a guided portion and a release portion;
the guided portion extends along the up-down direction; and
the release portion is located forward of the guided portion, and
the unlocking method comprising:
moving the release jig along the up-down direction in a state where the guide portion regulates a movement of the guided portion in the front-rear direction, so that the release portion is inserted into the gap; and
resiliently deforming the lock arm by the release portion inserted in the gap to cause the released portion of the lock arm to be moved outward of the structure in the lateral direction, so that the locked portion locked by the lock portion is unlocked.

2. A release jig configured to unlock a lock of a mated state of a structure which comprises a first member and a second member mateable with each other, wherein:
the first member has a lock arm;
the lock arm extends along a front-rear direction and is resiliently deformable;
the lock arm has a lock portion;
the second member has a locked portion;
the lock portion locks the locked portion under the mated state where the first member and the second member mated with each other, and thereby the mated state is locked;
the release jig has a guided portion and a release portion;
the guided portion extends along an up-down direction perpendicular to the front-rear direction;
the release portion is located forward of the guided portion;
the release portion is insertable inward of the lock arm in a lateral direction perpendicular to both the front-rear direction and the up-down direction by moving the release jig along the up-down direction while a movement of the guided portion in the front-rear direction is regulated; and
when inserted inward of the lock arm in the lateral direction, the release portion resiliently deforms the lock arm and thereby unlocks the locked portion locked by the lock portion.

3. The release jig as recited in claim 2, wherein the release portion has a surface which intersects with the up-down direction.

4. The release jig as recited in claim 2, wherein the guided portion has a lower end which is located below another lower end of the release portion.

5. The release jig as recited in claim 2, wherein the guided portion is larger than the release portion in the lateral direction.

6. The release jig as recited in claim 2, wherein:
the release portion has a deformation maintenance portion;
the deformation maintenance portion is an upper part of the release portion; and
the deformation maintenance portion has a constant size in the lateral direction.

7. The release jig as recited in claim 6, wherein the guided portion is larger than the lock arm in the up-down direction.

8. The release jig as recited in claim 2, wherein:
the release jig has two arms and a coupling portion;
the coupling portion couples the two arms together in the lateral direction;
each of the arms extends downward from the coupling portion;
each of the arms has the guided portion and the release portion;
the coupling portion has an abutment portion;
the second member has a stop portion; and
the abutment portion is brought into abutment with the stop portion when the release jig is moved along the up-down direction so that the locked portion locked by the lock portion is unlocked, and thereby the abutment portion defines a lower limit position of the release jig in a process in which the locked portion locked by the lock portion is unlocked.

9. A structure comprising a first member and a second member mateable with each other, wherein:
the first member has a lock arm;
the lock arm extends along a front-rear direction and is resiliently deformable;
the lock arm has a lock portion and a released portion;
the released portion is provided on a rear end part of the lock arm;
the second member has a locked portion, a facing portion and a guide channel;
the lock portion locks the locked portion under a mated state where the first member and the second member mated with each other, and thereby the mated state is locked;
the guide channel extends along an up-down direction perpendicular to the front-rear direction;
the facing portion is located forward of the guide channel and faces the released portion in a lateral direction perpendicular to both the front-rear direction and the up-down direction when the first member and the second member are under the mated state; and
when the structure under the mated state is seen along the up-down direction, a gap located between the facing portion and the released portion is visible.

10. The structure as recited in claim 9, wherein the guide channel opens upward and downward.

11. The structure as recited in claim 9, wherein:
the lock arm is formed with a recess;
the recess is located at the rear end part of the lock arm;
the recess opens rearward and is recessed toward an outside surface of the first member in the lateral direction; and
the released portion is a surface of the recess which intersects with the up-down direction.

12. The structure as recited in claim 9, wherein:
the lock arm of the first member includes two lock arms;
the two lock arms are apart from each other in the lateral direction;
the second member has two side portions and a stop portion;
the two side portions are located at opposite sides of the second member in the lateral direction, respectively;
each of the side portions has the locked portion, the facing portion and the guide channel; and
the stop portion faces upward and is located between the two side portions in the lateral direction.
